(19) United States
(12) Patent Application Publication
(10) Pub. No.: US 2008/0181158 A1
(43) Pub. Date: Jul. 31, 2008

(54) Notification of a Receiving Device About a Forthcoming Transmission Session

(75) Inventors: Imed Bouazizi, Tampere (FI); Rod Walsh, Tampere (FI); Igor Curcio, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 11/596,398

(22) PCT Filed: Mar. 9, 2006
(86) PCT No.: PCT/IB2006/050735

§ 371 Date: Nov. 9, 2007

Related U.S. Application Data
(60) Provisional application No. 60/665,901, filed on Mar. 24, 2005.

(51) Int. Cl. H04H 20/71; H04J 15/00

(52) U.S. Cl. 370/312

(57) ABSTRACT

For the notification of a receiving device about a forthcoming transmission session, an identifier of one of various possible types of identifiers in a transmission session is mapped to a transmission session identifier field. This field is used for notifying the receiving device. Further, a repetition value is added to the transmission session identifier field, which indicates whether the forthcoming transmission session is new or not. Further, the receiving device may release context data stored for a particular transmission session identifier, if an acquisition of data in transmission sessions identified by the transmission session identifier can be terminated.

### CROSS-REFERENCE TO RELATED APPLICATIONS

This application is the U.S. National Stage of International Application Number PCT/IB2006/050735 filed Mar. 9, 2006 which was published Sep. 28, 2006 in English under International Publication Number WO 2006/100616 and which in turn claims priority to U.S. Provisional Patent Application Ser. No. 60/665,901 filed Mar. 24, 2005.

### FIELD OF THE INVENTION

The invention relates to methods of notifying a receiving device about a forthcoming transmission session. The invention relates equally to corresponding transmitting devices, to corresponding receiving devices, to corresponding communication networks and communication systems and to corresponding software program products.

### BACKGROUND OF THE INVENTION

Multimedia Broadcast/Multicast Service (MBMS) is a point-to-multipoint service in which data is transmitted from a single source to multiple destinations at the same time. MBMS thus enables an efficient sharing of network resources when the same data has to be transmitted to several receivers.

The MBMS system can be divided into three functional layers, as illustrated in FIG. 1. A first layer 10 corresponds to the bearer services, a second layer 11 corresponds to the delivery method and a third layer 12 corresponds to the user services enabling applications.

An MBMS bearer service provides the mechanisms to transport multicast and broadcast Internet Protocol (IP) data to User Equipment efficiently. A delivery method can either be a download delivery method or a streaming delivery method. A delivery method may use one or many MBMS bearers and/or one or many point-to-point (OTO) bearers to deliver data. The user services enable applications on top of MBMS and may use one or several delivery methods to deliver the application data, for instance data for a multimedia messaging service (MMS) message.

The relation between the different functional layers is illustrated for an exemplary download delivery user service in FIG. 2. In this example, a single MBMS Bearer Service #x of the first layer is used for several MBMS Download Sessions #n, #n+1, etc., of the third layer. These MBMS Download Sessions are used for an MBMS download user service of the third layer.

MBMS sessions can be set up between a Broadcast Multicast-Service Center (BM-SC) and user equipment (UE) of a mobile communication system via a Gateway GPRS Support Node (GGSN) of the core network of the mobile communication system and a Radio Access Network (RAN) of the mobile communication system. The layer structure of FIG. 1 is thus valid for the BM-SC and the UE. The MBMS delivery method 11 is triggered at the BM-SC by an MBMS user service provider, which is connected to the BM-SC for example via the Internet. The BM-SC then activates the MBMS bearer services 10 that are to be used by the user service 12. Each bearer service is uniquely identified by a Temporary Mobile Group Identity (TMGI). The TMGI is allocated globally by the BM-SC and is composed of a local MBMS bearer service identity having a size of three octets, or bytes, as well as a Public Land Mobile Network (PLMN) identity of the PLMN to which the BM-SC belongs. The TMGI is equivalent to the IP multicast address and Access Point Name (APN) pair, and is used for an efficient identification of the employed MBMS bearer. The TMGI is transmitted to the UE during the MBMS session activation for multicast sessions or during service announcement for broadcast sessions.

When an MBMS session starts, the UE is notified about a starting or ongoing data transmission through an MBMS notification procedure, as illustrated in FIG. 3 by way of example for a GSM EDGE RAN (GERAN). The TMGI and an optional Session ID are provided by the BM-SC to a Base Station Controller (BSC) of the GERAN. The BSC pages the TMGI and the optional Session ID to the mobile stations (MS) constituting the UE to inform them about the starting data transmission. The paging is performed independently of the current state of the mobile stations, which may be idle or connected. After an optional pre-notification with a paging request comprising only the TMGI and the optional Session ID, the GERAN may also prompt the terminals by a further paging request to reply to notifications for per-cell counting purposes by means of a channel request. In this case, the mobile stations have to transmit a channel request to the BSC, if they are interested in the MBMS session. The GERAN may then count the incoming channel requests. The counting process is important to determine the most efficient data transmission mode for a given cell. In case only a few mobile stations are interested in an MBMS session in a given cell, the GERAN may decide to use point-to-point transmissions instead of a point-to-multipoint transmission in this cell. The mobile stations evaluate the TMGI and the Session ID for deciding whether they are interested in the MBMS session or not.

In case of session repetitions, the BM-SC should assign the same TMGI and the same Session ID to the MBMS session. This allows the mobile stations to recognize that the session is repeated and to decide not to receive the data in case they already received it correctly.

The BM-SC may also use the same Session ID to deliver post-repair data for a prior download delivery session. This would allow the mobile stations to ignore the repair data, when the original data was correctly received during the first transmission.

It has been proposed in the 3GPP TSG-SA#34 document Tdoc S4-050103 “Usage of MBMS Session Identity” of February 2005, that a single octet (one byte) Session ID shall be allocated by the BM-SC per file download. In the file delivery method, however, a file delivery session is identified by a session ID in a 16 or 32 bit field in the Asynchronous Layered Coding/Layered Coding Transport (ALC/LCT) protocol header. Given the short space of one octet that is available for the representation of the Session ID during the notification, the problem of how to use this field efficiently arises. The Session ID octet should carry enough information to allow the mobile stations to decide whether the data was already received or not. However, no direct mapping between the larger download session ID and the smaller MBMS Session ID is possible without loss of precision.

The document Tdoc S4-050103 further proposes the usage of a validity timer at the mobile stations. This validity timer is intended to limit the validity of a Session ID to a given time duration, after which the mobile station should assume that the data carried over the MBMS session with a previously received Session ID value is a new delivery or transmission and not a continuation or repetition. Once an instance of a Session ID has expired, the value may thus be used for another transmission, that is, for another Session ID instance. This is supposed to allow reusing Session IDs without risking that the UE misinterprets the Session ID as a previous MBMS transmission session instance.

This approach has the disadvantage, though, that each mobile station has to keep track of a timer for each received session, in order to decide whether the session is a repetition or a wrap around of the Session ID field that led to identical values. Wrap-around of a Session ID field refers to the situation that the shortened Session ID used for a preceding session is now used for a new session. Furthermore, it is difficult for the BM-SC to get an accurate estimate of the timer value that accounts for reuse and allows session repetition at the same time. The timer value has to be transported as a download session parameter of the Session Description Protocol (SDP). At this moment, the value of the timer might be unpredictable yet. The result is an inaccurate counting at the cell level. Furthermore, it is not possible to unambiguously determine the start time of a Session ID. For example, it might be inferred that received packets of a session ID start the UE timers, but due to packet losses, not all mobile stations will start their timers simultaneously.

Another problem arises from the fact that the usage of the Session ID is optional. Both, UE and BM-SC may decide to ignore the Session ID field. If the UE decides to ignore the Session ID field, the UE will simply not interpret the Session ID field. It will assume that the MBMS session is a new session and make its decision independently. If the BM-SC decides not to use the Session ID field, for instance by setting it to a default value, however, it has to be ensured that the UE will not misinterpret it.

### SUMMARY OF THE INVENTION

It is an object of the invention to overcome the above mentioned problems.

According to a first aspect of the invention, a first method of notifying a receiving device about a forthcoming transmission session is proposed, which comprises at a transmitting device selecting one of at least two different identifier types that are potentially transmitted in a transmission session. The method further comprises mapping at least one identifier of the selected identifiers types, which at least one identifier will be transmitted in the forthcoming transmission session, to a transmission session identifier. The method further comprises inserting the transmission session identifier into a transmission session identifier field. The method further comprises providing the transmission session identifier field for a notification of the receiving device about the forthcoming transmission session.

Moreover, a transmitting device comprising means for realizing the first method of the first aspect of the invention is proposed. Moreover, a communication network comprising such a transmitting device is proposed. Moreover, a communication system comprising such a transmitting device and a receiving device is proposed.

Moreover, a software program product is proposed, which stores a software code realizing the steps of the first method of the first aspect of the invention when running in a processing unit of a transmitting device.

According to the first aspect of the invention, a second method of notifying a receiving device about a forthcoming transmission session is proposed, which comprises at a receiving device receiving a notification about a forthcoming transmission session. This method further comprises comparing a transmission identifier in a transmission session identifier field in the notification with identifiers of at least two identifier types received in preceding transmission sessions. This method further comprises abstaining from acquiring data of the transmission session in case the transmission session identifier corresponds to an identifier received in a preceding transmission session, for which included data has been received correctly.

Moreover, a receiving device comprising means for realizing this second method of the first aspect of the invention is proposed. Moreover, a software program product is proposed, which stores a software code realizing the steps of the second method of the first aspect of the invention when running in a processing unit of a receiving device.

The first aspect of the invention proceeds from the idea that by choosing between different types of identifiers as a basis for the transmission session identifier, the granularity information can be set as required.

It is an advantage of the first aspect of the invention that it allows for a more flexible mapping of the transmission session identifier field. It allows, for example, avoiding redundancy of information in cases were one MBMS session is used for one download session, in which case the session could be identified through the TMGI. Allowing the transmission session identifier to be set on the basis of a file identifier will increase the accuracy of the counting, as terminals will decide a-priori whether to receive data or not on a file basis and thus on a finer granularity than on a session basis.

With a finer granularity, a receiving device can decide for each file whether to reply to the notification and whether to receive the data or not. For example, in case of a user session with two large files, if the same MBMS bearer session is used for both and one receiving device needs only one of them, this receiving device will still have to indicate to the network that it will receive both. Also some session repetitions may just include a subset of the original session, for instance only the most important files. Thus, if only one type of transmission session identifier is used, the user will have to recognize the session repetition as a new session and notify that it wants to receive the data. This can avoided by having finer granularity mapping on basis of files or file groups.

When implementing the invention, it has to be taken into account that while the fine granular mapping allows for a higher accuracy in the counting and a more efficient usage of the networks resources, more data has to be stored by the receiving device.

The at least two types of identifiers from which an identifier can be selected as a basis for the mapping to the transmission session identifier can be of various kinds.

The types of identifiers may comprise for instance a file identifier identifying a file of a transmission session. The transmission session identifier can be for example the least significant bits (LSBs) of a Transport Object Identifier TOI of the file.

The types of identifiers may further comprise for instance a group specific identifier identifying a file group of a transmission session. If the group is a File Delivery over Unidirectional Transport (FLUTE) file group, the transmission session identifier can be generated for example from a group specific identifier that is transmitted in a File Delivery Table (FDT) Instance ID.

The types of identifiers may further comprise for instance a list of file identifiers, each file identifier identifying a respective file of a group of files of a transmission session. In this case, the transmission session identifier can be generated for example from a list of TOIs representing the list of files.

The types of identifiers may further comprise for instance at least one identifier identifying an external file group. In this case, the transmission session identifier may be generated for example for a group of files, where the mapping between this group of files and the transmission session identifier is described in some other data entity. This other data entity can be for example a Short Messaging Service (SMS) message, an SDP file, etc., and be communicated separately to the transmitting device, for example by means of a FLUTE delivery, an SMS, etc.

The types of identifiers may further comprise for instance a common identifier identifying all files of a transmission session. For example, a single transmission session identifier may be created for all files declared in one FDT Instance. In this case, the transmission session identifier may be created from the LSBs of the FDT Instance ID.

The types of identifiers may further comprise for instance a delivery session identifier identifying a delivery session. The delivery session is the entire session for a complete application or user service, which may use one or more transmission sessions for transmitting the involved application data. In case one delivery session identifier is to be created for a download delivery session, the transmission session identifier may be generated from the LSBs of the Transport Session Identifier (TSI) or from the TMGI.

The types of identifiers may further comprise for instance a file Uniform Resource Identifier (FileURI) identifying a FLUTE File Delivery Table Instance of a transmission session. The FileURI can be used similarly as a TOI.

Finally, also a new type of identifiers can be defined in the session to provide a selectable specific identifier. For example, a new FDT field, including an element or an attribute, can be introduced to provide data, from which the transmission session identifier can be created.

The decision which identifier type is to be used can be made by the transmitting device. The transmitting device can, for instance, decide to create a transmission session for each large file or for a file group and assign to it a corresponding transmission session identifier.

The transmitting device can decide on how to map the content—for example files, file groups, files in an FDT instance, or file download sessions—based on some criteria. An example of such criteria could be a size limitation for data that is allowed to be transmitted over the same bearer session. In this case, the transmitting device may fit for example as many files of a download session as possible into one burst—and thus one transmission session—while not exceeding a given maximal size.

Also the proposed mapping can be of various kinds.

The mapping may include selecting at least a predetermined portion of the at least one identifier of the selected identifier type to obtain the transmission session identifier. For example, the least significant byte or a predetermined number of the LSBs of the identifier could be employed as the transmission session identifier.

The mapping may also include combining at least a respective portion of at least two identifiers of the selected identifier type to obtain the transmission session identifier.

The mapping may also include generating a hash value based on at least a portion of the at least one identifier of the selected identifier type to obtain the transmission session identifier. For instance, the binary sum of all related TOIs could be hashed. When using a hashing for the mapping, the employed hash function should be known at the transmitting device and the receiving device.

The transmission session identifier could have a size of one octet, that is, of eightbytes, but equally any other suitable size. Further, in case a predetermined portion of identifiers is used for a mapping to the transmission session identifier, this predetermined portion can be selected in various ways. For instance, the least or most significant octet, the LSBs or the most significant bits (MSBs) could be used, or the hash of the least or most significant four bytes, etc.

The same transmission session identifier can be used to describe different data that relate to same content. An example is as follows: the original data is sent by the transmitting device with transmission session identifier #10. Thereafter, the transmitting device generates repair data for the same content and hence reuses the same transmission session identifier #10, although the sessions do not carry exactly the same data.

According to a second aspect of the invention, a first method of notifying a receiving device about a forthcoming transmission session is proposed, which comprises at a transmitting device inserting into a transmission session identifier field a repetition value indicating whether the forthcoming transmission session is a repetition or not. This method further comprises providing the transmission session identifier field for a notification of the receiving device about the forthcoming transmission session.

Moreover, a transmitting device comprising means for realizing the first method of the second aspect of the invention is proposed. Moreover, a communication network comprising such a transmitting device is proposed. Moreover, a communication system comprising such a transmitting device and a receiving device is proposed. Moreover, a software program product is proposed, which stores a software code realizing the steps of the first method of the second aspect of the invention when running in a processing unit of a transmitting device.

According to a second aspect of the invention, a second method of notifying a receiving device about a forthcoming transmission session is proposed, which comprises at a receiving device receiving a notification about a forthcoming transmission session. The method further comprises evaluating a repetition value in a transmission session identifier field in the notification.

Moreover, a receiving device comprising means for realizing this second method of the second aspect of the invention is proposed. Moreover, a software program product is proposed, which stores a software code realizing the steps of the second method of the second aspect of the invention when running in a processing unit of a receiving device.

The second aspect of the invention proceeds from the consideration that in the case the transmitting device does not map the transmission session identifier, either the transmission of the transmission session identifier to the receiving device has to be avoided, or the receiving device has to be instructed implicitly or explicitly to ignore the transmission session identifier. It is proposed that the transmitting device includes a repetition value in a transmission session identifier field, which indicates whether the transmission session shall be considered to be new or not.

It is an advantage of the second aspect of the invention that it allows avoiding the maintenance, estimation, and signaling of validity timers to the receiving device. The timer estimation accuracy can also significantly influence the performance of a possible counting mechanism, so avoiding the a-priori signaling of a timer estimate will enhance the accuracy of the counting.

The repetition value also allows a better handling of ambiguity, that is, of cases in which the same transmission session identifier is used for different transmission sessions. For example, if a file identifier has a size of four octets and the transmission session identifier has a size of eight bits, the same transmission session identifier might be generated for different files with different TOIs. Due to this ambiguity, a receiving device may assume without the provision of a repetition value that a session is new but it then turns out it is not and that the data was already received. This situation is avoided by using the repetition value to indicate whether a session is a repetition or not.

In an exemplary embodiment of the second aspect of the invention, the most significant bit (MSB) of the transmission session identifier field is reserved to signal to the receiving device whether the following session is a repetition or not. A value of ‘0’ may then indicate that the session is a new session and a value of ‘1’ may indicate that the session is a repetition session, or vice versa.

In a preceding step of the second aspect of the invention, the transmission device may decide whether a transmission session identifier is to be used at all. The same predetermined repetition value may then be used for the case the transmission session is a new transmission session and for the case no transmission session identifier is to be used. Thus, when the transmission session identifier field is not used, there will always be an indication to the receiving device that the forthcoming transmission session is a new session.

Further, the transmitting device may set the repetition value to a value indicating that a forthcoming transmission session is a new transmission session after a predetermined period of time after the repetition value has last been set to a value indicating that a forthcoming transmission session is a new transmission session. The transmitting device may maintain to this end a timer for the validity of a given transmission session identifier. If the timer expires or if a wrap around is made, the transmission device may set the repetition value to a value indicating that a forthcoming transmission session is a new transmission session.

When the receiving device receives a notification about a forthcoming transmission session, it evaluates a repetition value in a transmission session identifier field in the notification. It may then responds to the notification in case the repetition value indicates that a forthcoming transmission session is a new transmission session. Alternatively or in addition, it may acquire the data of the forthcoming session in case the repetition value indicates that a forthcoming transmission session is a new transmission session.

It may further respond to this notification and/or acquire the data of the forthcoming session, in case the repetition value does not indicate that a forthcoming transmission session is a new transmission session but if it is determined that content of a corresponding preceding transmission session has not been received correctly.

According to a third aspect of the invention, a method of notifying a receiving device about a forthcoming transmission session is proposed, which comprises at a receiving device determining for a transmission session identifier that an acquisition of data in transmission sessions identified by the transmission session identifier can be terminated. The method further comprises releasing context data stored for this transmission session identifier.

Moreover, a receiving device comprising means for realizing this method of the third aspect of the invention is proposed. Moreover, a software program product is proposed, which stores a software code realizing the steps of the method of the third aspect of the invention when running in a processing unit of a receiving device.

The third aspect of the invention proceeds from the idea that in some cases, the receiving device can unequivocally determine by itself whether an acquisition of data of a particular transmission session is still appropriate or possible.

It is an advantage of the third approach of the invention that a wrap-around of transmission session identifiers is facilitated. It is further an advantage of the third approach of the invention that the receiving device knows at a relatively early point of time that it does not have to look out for a particular transmission session anymore.

There are several possible events based on which a receiving device may determine that context data on a transmission session identifier instance can be released.

As a first possible event, the entire related file or file group has been received correctly.

As a second possible event, the end of a file or file group transmission is detected or determined. This may be the case, for example, if the most recent FDT Instance describing a TOI expires, if the end-of-object is received, etc.

As a third possible event, the end of download session is detected or determined. This may be the case, for example, if the SDP end time is reached, if an end-of-session flag is received, etc.

Determining or detecting that the context data for a specific transmission session identifier instance may be released can be used, for instance, to indicate from an application part of the receiving device to a bearer part of the receiving device not to respond to notifications/pages for that session transmission identifier, for example a TMGI or a bearer identifier. If the receiving device is user equipment of a mobile communication system, as a result, this receiving device will not be counted in a cell based count of responding receiving devices. It has to be noted that if a receiving device receives multiple “transmission sessions” using the same transmission session identifier value, all of those “transmission sessions” should be released before the context data for the session transmission identifier is released.

It is to be understood that the different aspects of the invention can be employed by themselves or in any combination.

In either case, a transmitting device can be for example, though not exclusively, a BM-SC. In either case, a receiving device can be for example, though not exclusively, user equipment of a mobile communication system, like a mobile station. The transmission session can be for example, though not exclusively, an MBMS session providing for instance a streaming or download service.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram of the functional layers of an MBMS service delivery;

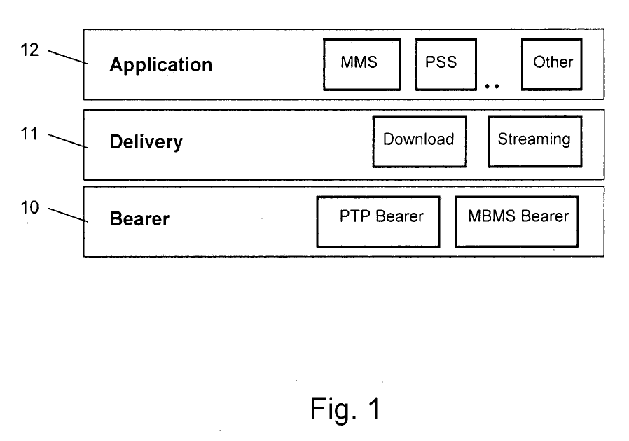

FIG. 2 is a schematic diagram illustrating the relation between the functional layers of FIG. 1;

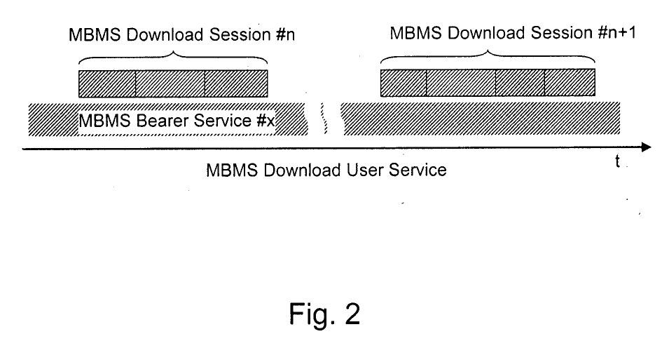

FIG. 3 is a schematic diagram illustrating the notification process for an MBMS session in GERAN;

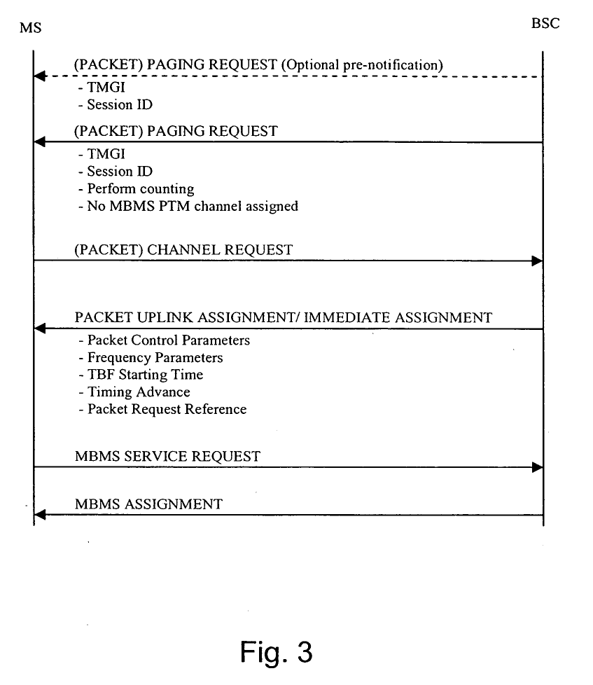

FIG. 4 is a schematic diagram of a communication system in which an embodiment of the invention can be implemented;

FIG. 5 is a schematic block diagram of an embodiment of a mobile terminal and of an embodiment of a BM-SC in the communication system of FIG. 4;

FIG. 6 is a flow chart schematically illustrating the operation at the BM-SC of FIG. 5;

FIG. 7 is a schematic diagram illustrating the structure of a Session ID field employed in the communication system of FIG. 4; and

FIG. 8 is a flow chart schematically illustrating the operation at the mobile terminal of FIG. 5.

### DETAILED DESCRIPTION OF THE INVENTION

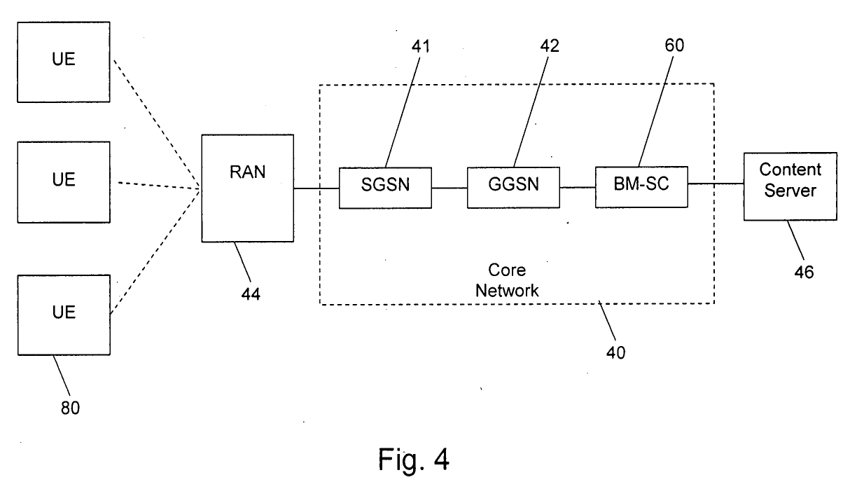

FIG. 4 is a schematic diagram of an exemplary communication system, in which a notification of user equipment about a forthcoming MBMS session can be implemented in accordance with the invention.

The communication system comprises a mobile communication network including a core network 40 and a plurality of radio access networks (RAN) 44, of which only one is depicted. Each RAN 44 serves mobile terminals 80, that is, user equipment UE, in one or more radio cells in a conventional manner. In the case of UMTS, for example, the RAN 44 may comprise to this end a plurality of RNCs and connected to each RNC a plurality of NodeBs, and in the case of GSM, for example, the RAN 44 may comprise to this end a plurality of BSCs and connected to each BSC a plurality of BTSs. The core network comprises a plurality of SGSNs (Serving GPRS Support Node) 41, of which only one is depicted, a GGSN 42 and a BM-SC 60. A content server 46 of an MBMS user service provider may be connected to the BM-SC 60 for example via the Internet (not shown). The BM-SC 60 enables MBMS sessions between the content server 46 and the mobile terminals 80 via the GGSN 42, a respective SGSN 41 and a respective RAN 44. The mobile stations 80 are thus receiving devices according to the invention, while the BM-SC 60 is a transmitting device according to the invention.

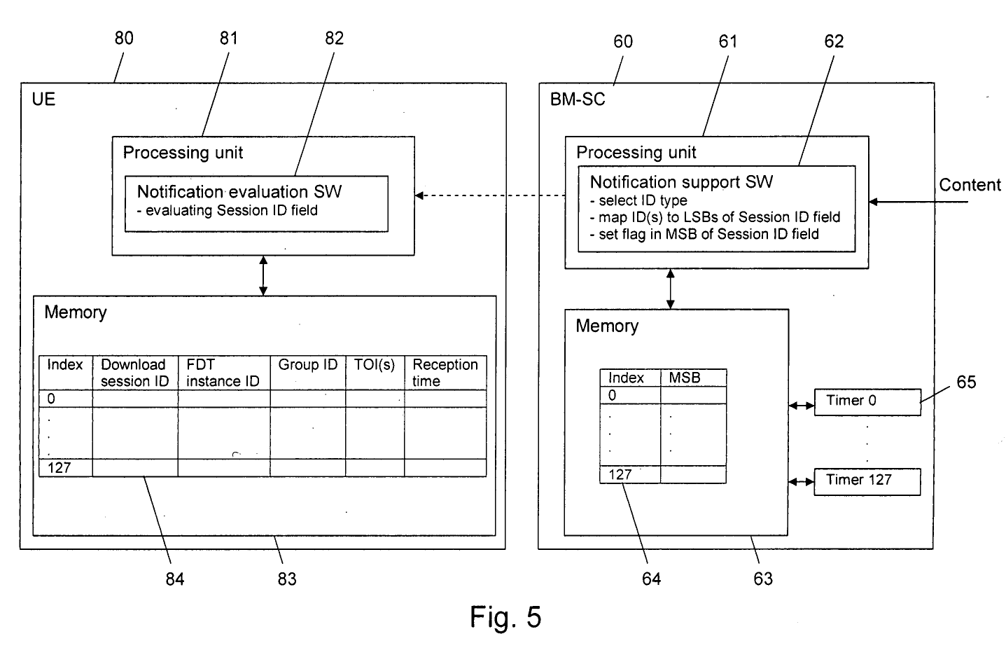

FIG. 5 is a block diagram illustrating some details of a mobile terminal 80 and of the BM-SC 60 of the communication system of FIG. 4 that are employed in the presented embodiment of the invention.

The BM-SC 60 comprises a processing unit 61 running software codes implemented in the BM-SC 60, including a notification support software 62. It is to be understood that the notification support software 62 may form a part of a more comprehensive software code used by the BM-SC 60. The BM-SC 60 further comprises a memory 63 storing a table 64 with 128 one-bit entries for each supported user service. That is, each table entry can have the value ‘0’ or the value ‘1’. The memory 63 can be accessed by the processing unit 61. The BM-SC further comprises 128 timers 65, wherein each timer 65 is associated to one of the table entries. Each timer 65 is reset every time the associated table entry is overwritten with the value ‘0’.

A table entry is overwritten with the value ‘0’ if the associated timer 65 expires or if a wrap around in the MBMS Session ID value occurs, that is, if a MBMS Session ID value is used for the first time for a new MBMS session.

The mobile terminal 80 comprises a processing unit 81 running software codes implemented in the mobile terminal 80, including a notification evaluation software 82. It is to be understood that the notification evaluation software 82 may form a part of a more comprehensive software code used by the mobile terminal 80. The mobile terminal 80 further comprises a memory 83 storing a table 84 with 128 entries for each requested user service. Each entry may comprise a download session ID, an FDT instance ID, a group ID, TOI(s) belonging to received data, and the reception time of data received with a respective MBMS Session ID field.

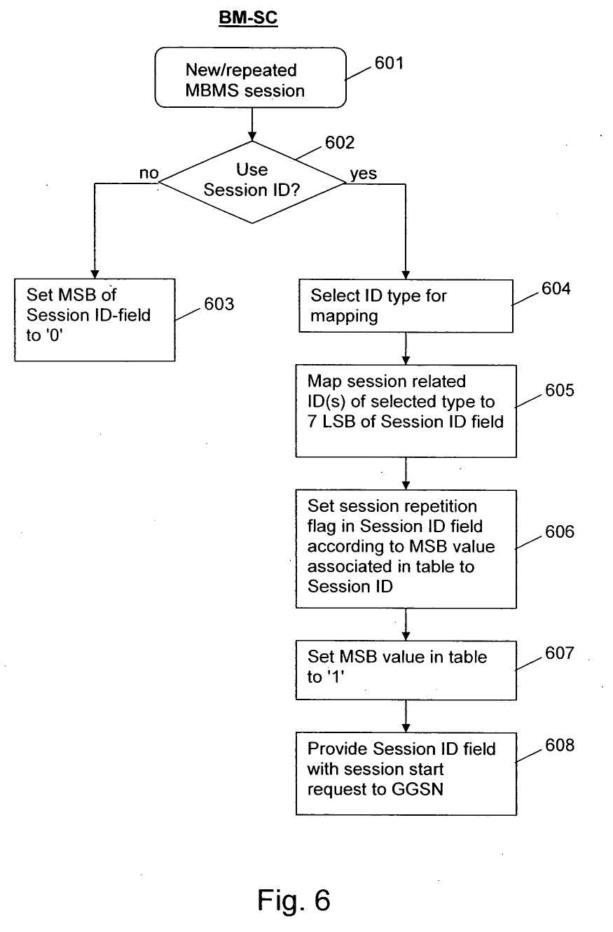

The operation in the communication system of FIG. 4 according to an embodiment of the invention will now be described with reference to FIGS. 6 to 8.

FIG. 6 is a flow chart illustrating the operation at the BM-SC 60. The indicated steps are performed more specifically by the processing unit 61 when running the notification support software 62.

When the BM-SC 60 intends to establish a new or a repeated MBMS session for transmitting content provided by the content server 46 for a particular user service (step 601), it first determines whether or not to make use of an MBMS Session ID, in order to enable a more accurate counting of mobile terminals wishing to participate in the MBMS session at a cell level (step 602).

If no MBMS Session ID is to be used, the BM-SC 60 sets the value of a MBMS session ID field to ‘0’ for the forthcoming download session (step 603).

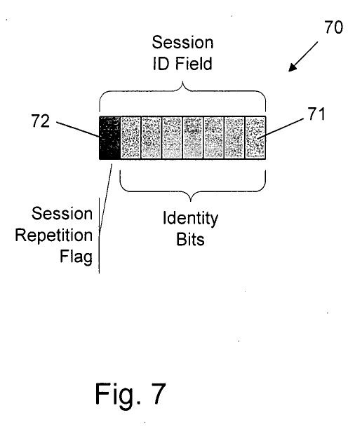

If an MBMS Session ID is to be used, the BM-SC 60 assembles the data for a MBMS session ID field for the forthcoming download session. The structure of such a MBMS session ID field is illustrated in FIG. 7. As can be seen, the MBMS session ID field 70 has the size of one octet and comprises seven LSBs for identity bits 71 and one bit for a session repetition flag 72.

The BM-SC 60 first selects the type of IDs belonging to the download session that are to be used for the generation of the MBMS Session ID. More specifically, the BM-SC 60 determines the content that is to be transmitted in the MBMS session and selects, based on this content, the appropriate identifier type. (step 604)

The BM-SC 60 selects, for example, a file of a download delivery session, a FLUTE file group, a file group, an external file group, all files declared in one FDT Instance or a download delivery session as a basis for generating the MBMS Session ID.

The BM-SC 60 then maps the respective ID or IDs of the selected ID type to the seven LSBs of the MBMS session ID field as an MBMS session ID. (step 605)

If the MBMS Session ID is to be created, for example, for a file of a download delivery session the BM-SC 60 maps the seven LSBs of the TOI of the file to the seven LSBs of the MBMS session ID field. If the MBMS Session ID is to be created, for example, for a FLUTE file group, the BM-SC 60 maps the seven LSBs of a group specific identifier that is transmitted in the FDT Instance ID to the seven LSBs of the MBMS session ID field. If the MBMS Session ID is to be created, for example, for a file group, the BM-SC 60 generates a value of seven bits from the list of TOIs representing the list of files, for instance by means of a hash function. The BM-SC 60 then maps this value to the seven LSBs of the MBMS session ID field. If the MBMS Session ID is to be created, for example, for an external file group, the BM-SC 60 uses a mapping between the files of this external file groups and an MBMS session ID defined in some other data entity, like an SMS, an SDP file, etc., which other data entity has been communicated separately to the BM-SC 60, for instance by means of a FLUTE delivery, an SMS, etc. Again, the MBMS Session ID may be based on a hash function applied to identifiers or portions of identifiers of single external files. The BM-SC 60 maps this MBMS session ID to the seven LSBs of the MBMS session ID field. If the MBMS Session ID is to be created, for example, for all files declared in one FDT Instance, the BM-SC 60 maps the seven LSBs of the FDT Instance ID to the seven LSBs of the MBMS session ID field. If the MBMS Session ID is to be created, for example, for a download delivery session, the BM-SC 60 maps the seven LSBs of the TSI to the seven LSBs of the MBMS session ID field.

The BM-SC 60 then reads the value of the MSB associated in the table 64 by its index to the determined MBMS Session ID and adds the value to the MBMS session ID field as a session repetition flag at the position of the MSB of the MBMS session ID field. (step 606)

In addition, the BM-SC 60 sets the MBS table entry to the value ‘1’. If the MBMS session is to be the last repetition of an MBMS session, however, the BM-SC 60 sets the MBS table entry to the value ‘0’. (step 607)

The MBMS session ID field and a TMGI are then provided to the GGSN 42 as parts of an MBMS session start request. (step 608) The TMGI is allocated globally by the BM-SC 60 in a conventional manner and comprises thus a local MBMS bearer service identity and the PLMN identity of the mobile communication network 40, 44.

The GGSN 42 takes care that a paging message including the TMGI and the session ID is generated and transmitted to the mobile terminals 80 via the RANs 44 as an MBMS session notification.

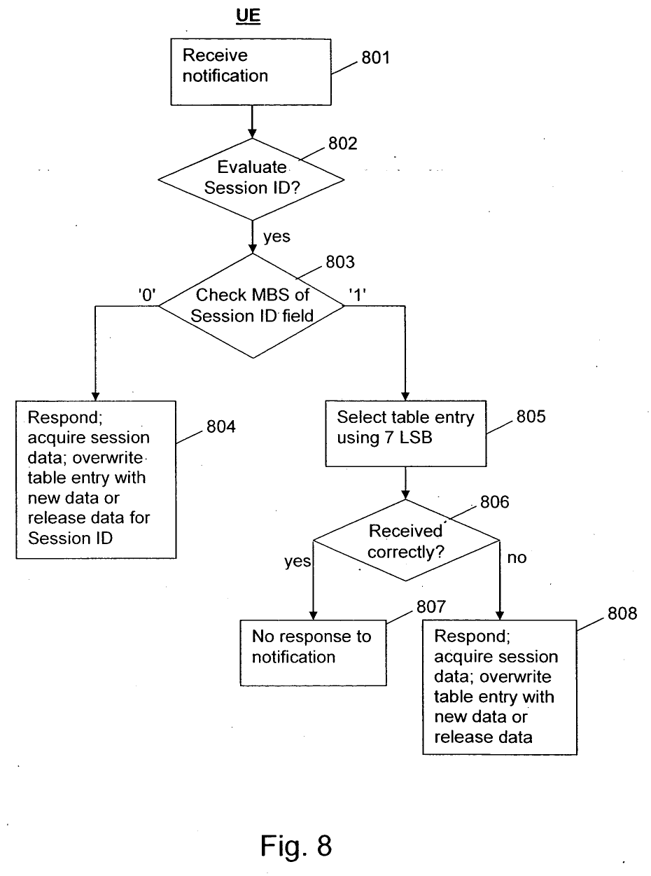

FIG. 8 is a flow chart illustrating the operation at the mobile terminal 80. The indicated steps are performed more specifically by the processing unit 81 when running the notification evaluation software 82.

When receiving a paging request (step 801), the mobile terminal 80 first decides whether an included MBMS session ID field should be evaluated (step 802).

If the mobile terminal 80 decides not to evaluate the MBMS session ID field, it acquires the data of the forthcoming MBMS session for deciding whether the data is still required or not (not indicated).

If the mobile terminal 80 decides to evaluate the MBMS session ID field, it first checks the session repetition flag corresponding to the MSB of the MBMS session ID field. (step 803)

If the value of the MSB of the MBMS session ID field is ‘0’, the mobile terminal assumes that the data in the forthcoming MBMB session is new data. In this case, the mobile terminal 80 responds to the paging request, acquires the data in the MBMS session and overwrites the associated entry in the table 83 with the new data after having correctly received the session data. The index of the associated entry corresponds to the seven LSBs of the MBMS session ID field. When the mobile terminal 80 detects an event, however, that indicates that the context data stored for this MBMS session is not required any more, the mobile terminal 80 releases the context data, that is, the data in the table entry associated to the MBMS session, so that the table entry can be used for another MBMS session. (step 804) It has to be noted that the arrival of new data is also assumed, if the BM-SC 60 decided not to make use of an MBMS Session ID, as in this case the MSB of the MBMS session ID field is equally set to ‘0’. In this case, the index of the associated entry can be determined by the mobile station 80 based on an identifier in the acquired data.

If the value of the MSB of the MBMS session ID field is ‘1’, the mobile terminal 80 interprets this value as an indication of a session repetition. It selects the table entry having an index which corresponds to the seven LSBs of the MBMS session ID field (step 805). If the item corresponding to this table entry is identified in the table 84 as having been received correctly (step 806), the mobile terminal 80 does not respond to the MBMS notification message (step 807). If the item corresponding to this table entry is not identified in the table 84 as having been received correctly (step 806), in contrast, the mobile terminal 80 responds to the MBMS notification message. In addition, it acquires the data in the MBMS session and overwrites the associated entry in the table 83 with the new data after having correctly received the session data. When the mobile terminal 80 detect an event, however, that indicates that the context data is not required any more, the mobile terminal 80 releases the associated table entry so that it can be used for another transmission session. (step 808).

Thus, an accurate counting of the mobile terminals in a respective cell is allowed in the RAN 44 serving this cell, since only those mobile terminals respond to a paging message, which actually need the transmission. Consequently, the most appropriate transmission type, that is, point-to-point or point-to-multipoint, can be selected for the MBMS session in this cell, without requiring the mobile stations to use timers for determining the validity of the received MBMS Session IDs. Further, the finer granularity helps avoiding the transmission of redundant information.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method comprising:
selecting one of at least two different identifier types that are potentially transmitted at a transmitting device in a transmission session;
mapping at least one identifier of said selected identifiers types, which at least one identifier is transmitted in said forthcoming transmission session, to a transmission session identifier;
inserting said transmission session identifier into a transmission session identifier field; and
providing said transmission session identifier field for a notification of a receiving device about said forthcoming transmission session.

2. The method according to claim 1, wherein said at least two types of identifiers comprise at least one of:
a file identifier identifying a file of a transmission session;
a group specific identifier identifying a file group of a transmission session;
a list of file identifiers, each file identifiers identifying a respective file of a group of files of a transmission session;
at least one identifier identifying an external file group;
a common identifier identifying all files of a transmission session;
a delivery session identifier identifying a delivery session; and
a file uniform resource identifier identifying a file delivery over unidirectional transport file delivery table instance of a transmission session.

3. The method according to claim 1, wherein said mapping includes selecting at least a predetermined portion of said at least one identifier of said selected identifier type to obtain said transmission session identifier.

4. The method according to claim 1, wherein said mapping includes combining at least a respective portion of at least two identifiers of said selected identifier type to obtain said transmission session identifier.

5. The method according to claim 1, wherein said mapping includes generating a hash value based on at least a portion of said at least one identifier of said selected identifier type to obtain said transmission session identifier.

6. The method according to claim 1, wherein said receiving device receives a notification about a forthcoming transmission session, compares a transmission identifier in a transmission session identifier field in said notification with identifiers of at least two identifier type received in preceding transmission sessions, and abstains from acquiring data of said transmission session in case said transmission session identifier corresponds to an identifier received in a preceding transmission session, for which included data has been received correctly.

7. A transmitting device comprising a processing unit supporting a notification of a receiving device about a forthcoming transmission session,
wherein said processing component is adapted to select one of at least two different identifier types that are potentially transmitted in a transmission session;
wherein said processing component is adapted to map at least one identifier of selected identifiers types, which at least one identifier is transmitted in a forthcoming transmission session, to a transmission session identifier;
wherein said processing component is adapted to insert said transmission session identifier into a transmission session identifier field; and
wherein said processing component is adapted to provide said transmission session identifier field for a notification of said receiving device about said forthcoming transmission session.

8. A communication network comprising the transmitting device of claim 7.

9. A communication system comprising the transmitting device of claim 7 and said receiving device.

10. A software program product in which a software code for notifying a receiving device about a forthcoming transmission session is stored, said software code realizing the following when running in a processing unit of a transmitting device:
selecting one of at least two different identifier types that are potentially transmitted in a transmission session;
mapping at least one identifier of said selected identifiers types, which at least one identifier is transmitted in said forthcoming transmission session, to a transmission session identifier;
inserting said transmission session identifier into a transmission session identifier field; and
providing said transmission session identifier field for a notification of said receiving device about said forthcoming transmission session.

11. A method comprising:
receiving a notification about a forthcoming transmission session at a receiving device,
comparing a transmission identifier in a transmission session identifier field in said notification with identifiers of at least two identifier types received in preceding transmission sessions; and
abstaining from acquiring data of said transmission session in case said transmission session identifier corresponds to an identifier received in a preceding transmission session, for which included data has been received correctly.

12. A receiving apparatus-comprising a processing unit supporting a notification of said receiving device about a forthcoming transmission session,
wherein said processing component is adapted to receive a notification about a forthcoming transmission session,
wherein said processing component is adapted to compare a transmission identifier in a transmission session identifier field in said notification with identifiers of at least two identifier type received in preceding transmission sessions; and
wherein said processing component is adapted to abstain from acquiring data of said transmission session in case said transmission session identifier corresponds to an identifier received in a preceding transmission session, for which included data has been received correctly.

13. A software program product in which a software code for notifying a receiving device about a forthcoming transmission session is stored, said software code realizing the following when running in a processing unit of receiving device:
receiving a notification about a forthcoming transmission session,
comparing a transmission identifier in a transmission session identifier field in said notification with identifiers of at least two identifier types received in preceding transmission sessions; and
abstaining from acquiring data of said transmission session in case said transmission session identifier corresponds to an identifier received in a preceding transmission session, for which included data has been received correctly.

14. A method comprising:
inserting at a transmitting device a repetition value indicating whether a forthcoming transmission session is a repetition or not into a transmission session identifier field; and
providing said transmission session identifier field for a notification of said receiving device about said forthcoming transmission session.

15. The method according to claim 14, further comprising preceedingly deciding whether a transmission session identifier is to be provided, and using the same predetermined repetition value for the case said transmission session is a new transmission session and for the case no transmission session identifier is to be provided.

16. The method according to claim 14, wherein said transmitting device sets said repetition value to a value indicating that a forthcoming transmission session is a new transmission session after a predetermined period of time after said repetition value has last been set to a value indicating that a forthcoming transmission session is a new transmission session.

17. The method according to claim 14, wherein said receiving device receives a notification about a forthcoming transmission session, evaluates a repetition value in a transmission session identifier field in said notification, and, in case said repetition value indicates that a forthcoming transmission session is a new transmission session, at least one of responds to said notification and acquires data belonging to said forthcoming transmission session.

18. The method according to claim 17, wherein further in case said repetition value does not indicate that a forthcoming transmission session is a new transmission session but it is determined that content of a corresponding preceding transmission session has not been received correctly, said receiving device at least one of responds to said notification and acquires data belonging to said forthcoming transmission session.

19. A transmitting device comprising a processing unit supporting a notification of a receiving device about a forthcoming transmission session,
wherein said processing component is adapted to insert a repetition value indicating whether said forthcoming transmission session is a repetition or not into a transmission session identifier field; and
wherein said processing component is adapted to provide said transmission session identifier field for a notification of said receiving device about said forthcoming transmission session.

20. A communication network comprising the transmitting device of claim 19.

21. A communication system comprising the transmitting device of claim 19 and said receiving device.

22. A software program product in which a software code for notifying a receiving device about a forthcoming transmission session is stored, said software code realizing the following when running in a processing unit of a transmitting device:
inserting a repetition value indicating whether said forthcoming transmission session is a repetition or not into a transmission session identifier field; and
providing said transmission session identifier field for a notification of said receiving device about said forthcoming transmission session.

23. A method comprising:
receiving at a receiver device a notification about a forthcoming transmission session; and
evaluating a repetition value in a transmission session identifier field in said notification.

24. A receiving device comprising a processing unit supporting a notification of a receiving device about a forthcoming transmission session,
wherein said processing component is adapted to receive a notification about a forthcoming transmission session; and
wherein said processing component is adapted to evaluate a repetition value in a transmission session identifier field in said notification.

25. A software program product in which a software code for notifying a receiving device about a forthcoming transmission session is stored, said software code realizing the following steps when running in a processing unit of a receiving device:
receiving a notification about a forthcoming transmission session; and
evaluating a repetition value in a transmission session identifier field in said notification.

26. A method comprising:
determining for a transmission session identifier at a receiving device, for which context data is stored, that an acquisition of data in transmission sessions identified by said transmission session identifier can be terminated; and
releasing context data stored for said transmission session identifier.

27. A receiving device comprising a processing unit supporting a notification of a receiving device about a forthcoming transmission session,
wherein said processing component is adapted to determine for a transmission session identifier, for which context data is stored, that an acquisition of data in transmission sessions identified by said transmission session identifier can be terminated; and
wherein said processing component is adapted to release context data stored for said transmission session identifier.

28. A communication system comprising the receiving device of claim 27.

29. A software program product in which a software code for notifying a receiving device about a forthcoming transmission session is stored, said software code realizing the following when running in a processing unit of a receiving device:
receiving a notification about a forthcoming transmission session,
evaluating a repetition value in a transmission session identifier field in said notification; and
responding to said notification in case said repetition value indicates that a forthcoming transmission session is a new transmission session.

30. An apparatus comprising:
means for selecting one of at least two different identifier types that are potentially transmitted at said apparatus in a transmission session;
mapping at least one identifier of said selected identifiers types, which at least one identifier is transmitted in said forthcoming transmission session, to a transmission session identifier;
inserting said transmission session identifier into a transmission session identifier field; and
providing said transmission session identifier field for a notification of a receiving device about said forthcoming transmission session.

31. The apparatus according to claim 30, wherein said at least two types of identifiers comprise at least one of:
a file identifier identifying a file of a transmission session;
a group specific identifier identifying a file group of a transmission session;
a list of file identifiers, each file identifiers identifying a respective file of a group of files of a transmission session;
at least one identifier identifying an external file group;
a common identifier identifying all files of a transmission session;
a delivery session identifier identifying a delivery session; and
a file uniform resource identifier identifying a file delivery over unidirectional transport file delivery table instance of a transmission session.
